(19) United States
(12) Patent Application Publication
(10) Pub. No.: US 2012/0072735 A1
(43) Pub. Date: Mar. 22, 2012

(54) STORAGE DEVICE, PROTECTION METHOD, AND ELECTRONIC DEVICE

(75) Inventors: Kiyotaka FUKAWA, Tokyo (JP); Teruji YAMAKAWA, Tokyo (JP)

(73) Assignee: Kabushiki Kaisha Toshiba, Tokyo (JP)

(21) Appl. No.: 13/098,009

(22) Filed: Apr. 29, 2011

(30) Foreign Application Priority Data
Sep. 17, 2010 (JP) 2010-209710

(51) Int. Cl. H04L 9/00

(52) U.S. Cl. 713/189

(57) ABSTRACT

According to one embodiment, a storage device encrypts/decrypts data with an encryption key to write/read the data to/from the storage area. In the storage device, an elapsed time counter starts counting triggered by turning on of the storage device. A receiver receives a command containing a password and time information from a host device. The time information indicates current date and time. A calculator calculates elapsed time from last command input to current command input based on the time information and a counter value. An adder adds the elapsed time to time information contained in a command received last time. A time information determination module determines the consistency of the time information. A disabling module disables the encryption key if the time information is not consistent. An authentication module authenticates the password if the time information is consistent and allows access to the storage area if the password is successfully authenticated.

### CROSS-REFERENCE TO RELATED APPLICATIONS

This application is based upon and claims the benefit of priority from Japanese Patent Application No. 2010-209710, filed Sep. 17, 2010, the entire contents of which are incorporated herein by reference.

### FIELD

Embodiments described herein relate generally to a storage device, a protection method, and an electronic device.

### BACKGROUND

There have been known storage devices that automatically encrypt data to be stored to prevent the leakage of the data. The function of such a storage device is known as self encrypting disk (SED) function. The storage device having the SED function generates an encryption key based on a predetermined password. When the password is input to the storage device from a host device, encrypted data can be decrypted.

There is a conventional technology to protect the storage device connected to the host device against a hot-plug attack. According to the conventional technology, timers of the storage device and the host device are synchronized. From a timing value for the synchronization, common data is generated to authenticate both the devices.

In information leakage prevention technology using the SED function, a password may be read from a flow of information between the host device and the storage device, and there is room for improvement. Besides, in the conventional technology in which timers are synchronized between the host device and the storage device, although the connection relationship between the devices can be verified, both the devices require a mechanism and processing for the timer synchronization. Thus, there is a need for technology that improves the security of the storage device with a more simple structure even when the host device and the storage device are in proper connection relationship.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a configuration an electronic device according to an embodiment;

FIG. 2 is an exemplary block diagram of a hardware configuration of a magnetic disk device in the embodiment;

FIG. 3 is an exemplary functional block diagram of the magnetic disk device in the embodiment;

FIG. 4 is an exemplary flowchart of the operation of the magnetic disk device to receive a command in the embodiment;

FIG. 5 is an exemplary flowchart of the a time information determination process in the embodiment;

FIG. 6 is an exemplary schematic diagram for explaining the time information determination process in the embodiment; and

FIG. 7 is an exemplary flowchart of a valid time determination process in the embodiment.

### DETAILED DESCRIPTION

In general, according to one embodiment, a storage device is configured to encrypt data with an encryption key, to store the data in a storage area, and to decrypt the data stored in the storage area with the encryption key. The storage device comprises an elapsed time counter, a receiver, a calculator, an adder, a time information determination module, a disabling module, and an authentication module. The elapsed time counter is configured to start counting triggered by turning on of the storage device. The receiver is configured to receive a command that contains a password and time information from a host device connected to the storage device. The time information indicates current date and time measured by the host device. The calculator is configured to calculate elapsed time from last command input to current command input based on the time information contained in the command and a counter value counted by the elapsed time counter until the command is received. The adder is configured to add the elapsed time calculated by the calculator to time information contained in a last command received last time. The time information determination module is configured to determine the consistency of the time information contained in the current command based on a temporal relationship between a result of addition by the adder and the time information. The disabling module is configured to disable the encryption key if the time information determination module determines that the time information is not consistent. The authentication module is configured to authenticate the password contained in the current command if the time information determination module determines that the time information is consistent, and allow access to the storage area if the password is successfully authenticated.

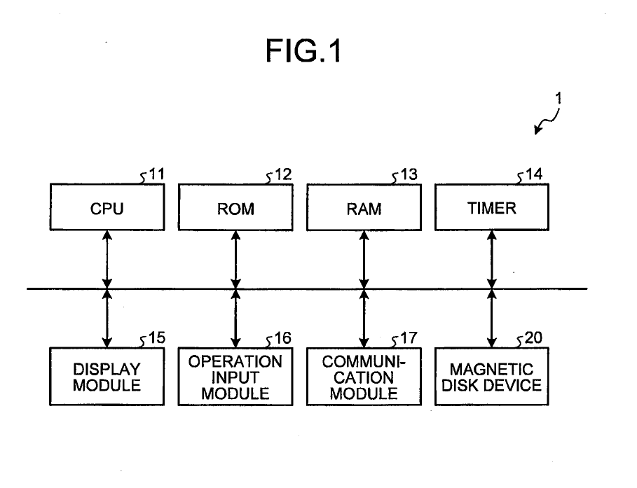

FIG. 1 is a schematic diagram of a configuration of a host device 1 as an electronic device according to an embodiment. The host device 1 may be, for example, a personal computer. As illustrated in FIG. 1, the host device 1 comprises a central processing unit (CPU) 11, a read only memory (ROM) 12, a random access memory (RAM) 13, a timer 14, a display module 15, an operation input module 16, a communication module 17, and a magnetic disk device 20.

The CPU 11 executes various programs stored in advance in the ROM 12 or the magnetic disk device 20 using a predetermined area of the RAM 13 as a work area, thereby controlling the overall operation of the host device 1.

The ROM 12 is a nonvolatile storage device and stores programs related to the control of the host device 1 and various types of setting information in an unrewritable manner. The RAM 13 is a volatile storage device and provides a work area of the CPU 11. The RAM 13 functions as a stack or a buffer during various types of processing.

The timer 14 may be, for example, a real time clock (RTC) provided to the host device 1, and generates time information indicating current date and time. The time information is represented by the number of seconds elapsed since a predetermined date (for example, Jan. 1, 1900). For example, if current date and time is Nov. 12, 2010 13:14:15, the time information is represented as “D08A5F27” in hexadecimal.

The display module 15 comprises a display device such as a liquid crystal display (LCD), and displays various types of information based on a display signal from the CPU 11. The operation input module 16 comprises various input keys. The operation input module 16 receives information input by the user as a command signal and outputs the command signal to the CPU 11. The display module 15 and the operation input module 16 may integrally constitute a touch panel.

The communication module 17 is an communication interface to communicate with an external device via a network (not illustrated). The communication module 17 outputs various types of information received from external devices to the CPU 11, and also transmits various types of information output from the CPU 11 to external devices.

The magnetic disk device 20, i.e., an example of a storage device of the embodiment, comprises a magnetically recordable storage medium. The magnetic disk device 20 stores programs related to the control of the host device 1 and various types of data in a rewritable manner. The magnetic disk device 20 has the self encrypting disk (SED) function, and stores data encrypted by a predetermined encryption algorithm such as advanced encryption standard (AES). In the embodiment, the magnetic disk device 20 is described as a storage device such as a hard disk drive (HDD) connected to the host device 1, it is not limited thereto. The storage device of the embodiment may comprises, as the storage medium, a semiconductor memory such as a solid state drive (SSD), a flash memory, or the like.

The magnetic disk device 20 determines whether access from the host device 1 is authorized based on a predetermined password and time information. Only if determining that the access is authorized, the magnetic disk device 20 allows data read/write with respect to the storage medium. Accordingly, upon accessing the magnetic disk device 20, the CPU 11 sends an authentication command containing a data read/write command, a predetermined password for decryption, and time information obtained from the timer 14 to the magnetic disk device 20. The CPU 11 implements the operation related to the access to the magnetic disk device 20 with the programs and the various types of setting information stored in the ROM 12.

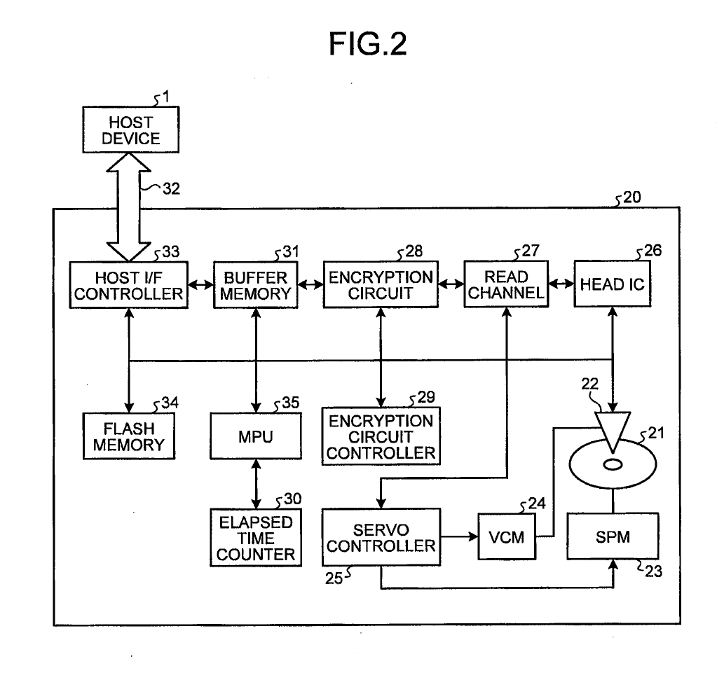

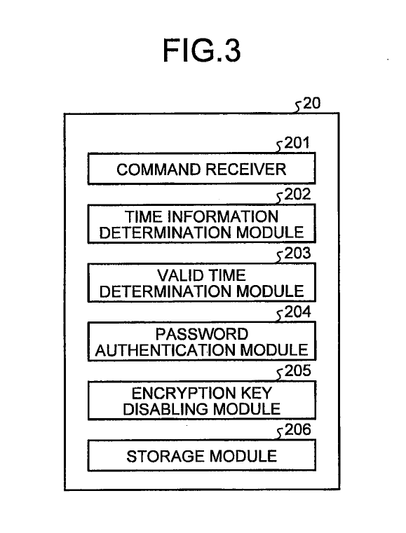

A configuration of the magnetic disk device 20 will be described with reference to FIGS. 2 and 3. FIG. 2 is a block diagram of a hardware configuration of the magnetic disk device 20.

As illustrated in FIG. 2, the magnetic disk device 20 comprises a disk medium 21, a head 22, a spindle motor (SPM) 23, a voice coil motor (VCM) 24, a servo controller 25, a head integrated circuit (IC) 26, a read channel 27, an encryption circuit 28, an encryption circuit controller 29, an elapsed time counter 30, a buffer memory 31, a host interface (I/F) 32, a host I/F controller 33, a flash memory 34, and a micro processing unit (MPU) 35.

The disk medium 21 is a storage medium that stores data as a signal. The head 22 writes a signal to the disk medium 21 as well as reading a signal from the disk medium 21. The SPM 23 drives the disk medium 21 to rotate. The VCM 24 comprises a magnet and a drive coil (not illustrated), and drives the head 22. The servo controller 25 controls the SPM and the VCM 24. The head IC 26 amplifies a signal to be written to/read from the disk medium 21 by the head 22. The read channel 27 converts data to be written to the disk medium 21 to a signal, and converts a signal read from the disk medium 21 to data. The encryption circuit 28 encrypts data to be written to the disk medium 21 by a predetermined encryption algorithm such as AES using an encryption key, which will be described later. The encryption circuit 28 decrypts the data read from the disk medium 21 using the encryption key. The encryption circuit controller 29 controls the operation of the encryption circuit 28.

The elapsed time counter 30 is a counter circuit or the like provided to the magnetic disk device 20. The elapsed time counter 30 starts counting simultaneously with the time the magnetic disk device 20 is turned on, and counts the elapsed time from the power-on by a counter value. The counting starts from the counter value “0” each time the power is turned on.

The buffer memory 31 temporarily stores data to be written to the disk medium 21, data read from the disk medium 21, and the like. The host I/F 32 is an interface to connect between the host device 1 and the magnetic disk device 20, and contributes to communication related to the exchange of data and commands between the host device 1 and the magnetic disk device 20. The host I/F controller 33 controls communication performed through the host I/F 32.

The flash memory 34 is a nonvolatile memory that stores programs to be executed by the MPU 35, various types of setting information related to the operation of the magnetic disk device 20, and the like. The MPU 35 implements functional modules, which will be described later, by executing the program stored in the flash memory 34. The MPU 35 controls the overall operation of the magnetic disk device 20.

FIG. 3 is a functional block diagram of the magnetic disk device 20. As illustrated in FIG. 3, the magnetic disk device 20 comprises a command receiver 201, a time information determination module 202, a valid time determination module 203, a password authentication module 204, an encryption key disabling module 205, and a storage module 206.

The command receiver 201 is a functional module that controls the receipt of a command (authentication command) received via the host I/F 32 and the host I/F controller 33. More specifically, at the time to start receiving commands (when the magnetic disk device 20 is turned on), the command receiver 201 checks a boot-time disabling flag and an unauthorized use flag stored in the storage module 206. If both the flags are not set, the command receiver 201 determines that the magnetic disk device 20 is turned off properly last time, and starts receiving commands from the host device 1. On the other hand, if any one of the boot-time disabling flag and the unauthorized use flag is set, the command receiver 201 determines that incorrect operation is performed, and does not receive a command.

The boot-time disabling flag is flag information that is set when predetermined operation that may be incorrect operation (for example, password authentication failure) takes place on the magnetic disk device 20. Meanwhile, the unauthorized use flag is flag information that is set when predetermined operation defined as incorrect operation (for example, a predetermined number of password authentication failures) takes place.

If the unauthorized use flag is set while the magnetic disk device 20 is in operation, the command receiver 201 stops receiving commands from the host device 1 for a predetermined time period. After the predetermined time period has elapsed, the command receiver 201 restarts receiving commands. The time period for which command receiving is stopped is set in advance in the storage module 206 (the flash memory 34, etc.) as setting information.

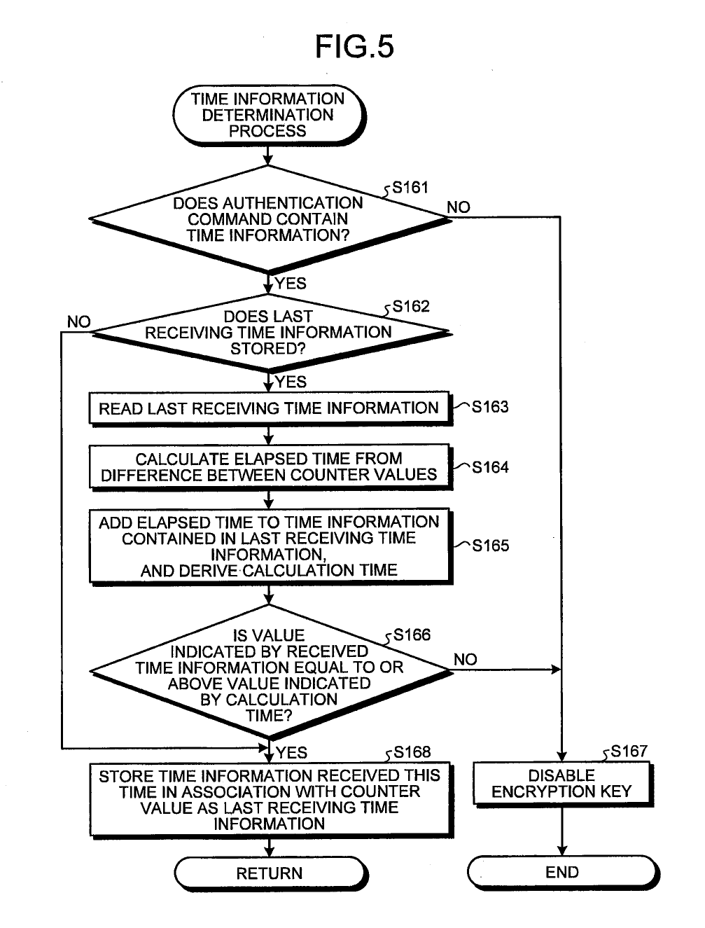

The time information determination module 202 performs time information determination process to determine the temporal consistency of time information based on the time information sent from the host device 1 as an authentication command and a counter value counted by the elapsed time counter 30. The time information determination process will be described in detail later with reference to FIG. 5.

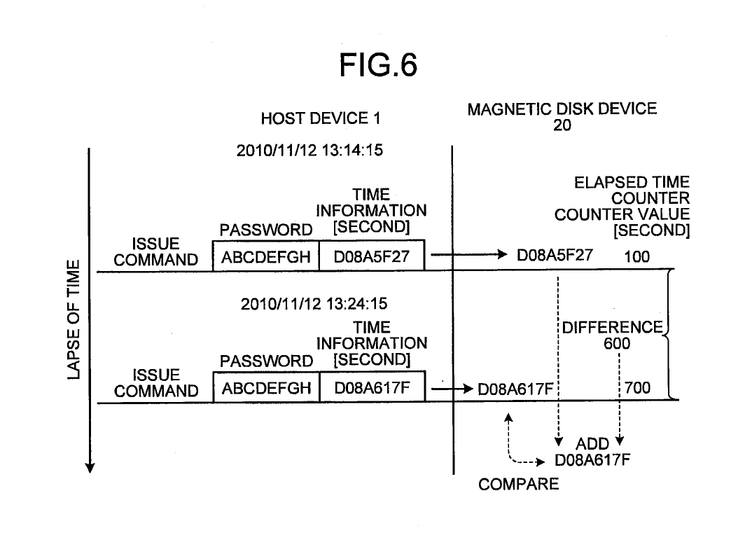

The valid time determination module 203 performs valid time determination process to determine whether an encryption key stored in the storage module 206 is valid based on encryption key valid time defined as a time period during which the encryption key is valid. The valid time determination process will be described in detail later with reference to FIG. 6.

The password authentication module 204 compares a password contained in the authentication command with a check password, which will be described later, stored in the storage module 206 to check the password. The password authentication module 204 determines whether the passwords match to authenticate the password.

The password authentication module 204 detects the number of times an authentication command is received per unit time (input count). If the input count exceeds a predetermined threshold, the password authentication module 204 determines that authentication commands are received sequentially in a short time. In this case, there may be a possibility that a password attack, such as brute force attack, has been attempted as described below. Thus, the password authentication module 204 determines that incorrect operation is performed. The threshold to determine incorrect operation is set in advance in the storage module 206 (the flash memory 34, etc.) as setting information.

Having determined that the passwords do not match, i.e., password authentication fails, the password authentication module 204 determines that incorrect operation may be performed, and sets the boot-time disabling flag. If password authentication fails a predetermined number of times, the password authentication module 204 determines that incorrect operation is performed, and sets the unauthorized use flag. If password authentication is successfully achieved, the password authentication module 204 clears the boot-time disabling flag and the unauthorized use flag, and allows access to the magnetic disk device 20 (the disk medium 21).

The encryption key disabling module 205 is a functional module that disables the encryption key according to the determination results of the functional modules described above. The disabling of the encryption key refers herein to disabling data encryption/decryption with the encryption key. That is, this is aimed at preventing data recorded on the disk medium 21 from being read as well as preventing data from being written to the disk medium 21.

The encryption key may be disabled, for example, by deleting the encryption key, or by encrypting the encryption key to replace a character string (data) that constitutes the encryption key with another character string. In the latter case, there may be provided a mechanism to restore (decrypt) the encrypted encryption key the character string of which is replaced.

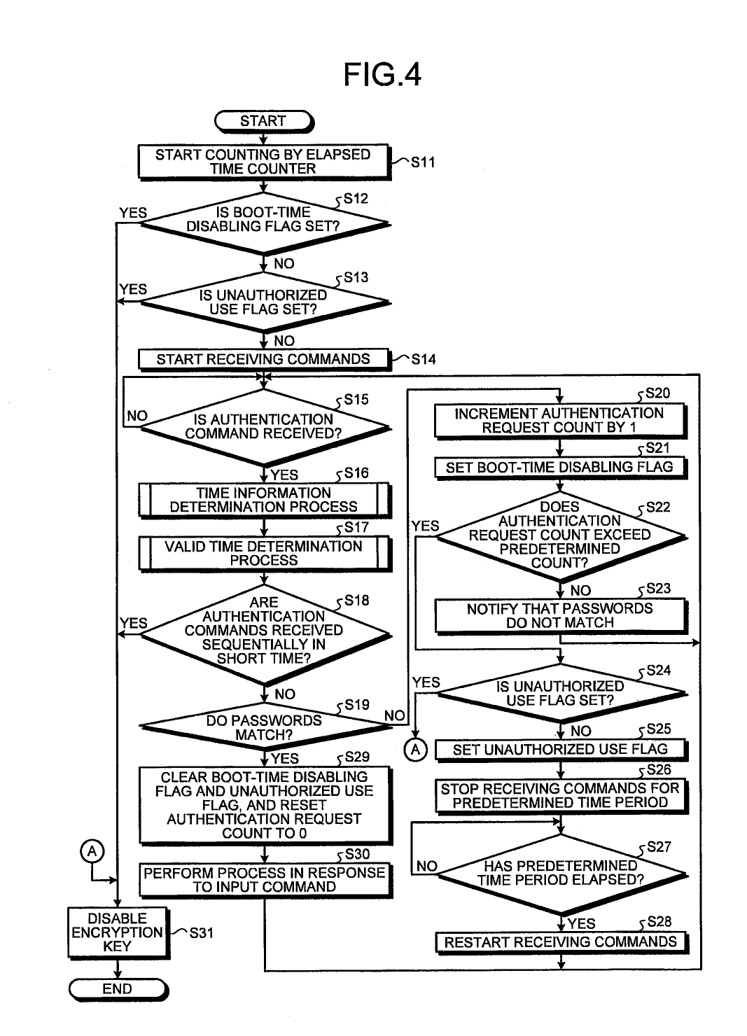

The storage module 206 is a functional module realized by a predetermined storage area of the nonvolatile memory of the magnetic disk device 20 such as the flash memory 34 or the disk medium 21. The storage module 206 stores various types of information to perform the process of receiving a command, which will be described in detail later with reference to FIG. 4.

More specifically, the storage module 206 stores, as the information to perform the process of receiving a command, a check password, an encryption key, password setting date and time, encryption key valid time, a boot-time disabling flag and a unauthorized use flag as described above, and the like.

The check password is a legitimate password related to the use of the magnetic disk device 20, and used to check a password sent from the host device 1. The encryption key is generated by the encryption circuit 28 under the control of the encryption circuit controller 29, and used to encrypt/decrypt data. The encryption key is generated when the check password is set. The encryption key may be generated in any manner, for example, using the check password as a generation seed.

The password setting date and time is information indicating the date and time when the check password is set. As with the time information described above, the password setting date and time is represented by the number of seconds elapsed since a predetermined date (for example, Jan. 1, 1900). The encryption key valid time is information that defines the valid time (seconds) of the encryption key, and is based on the password setting date and time, i.e., the date and time when the encryption key is generated.

With reference to FIGS. 4 to 7, a description will be given of the operation of the magnetic disk device 20 configured as above. FIG. 4 is a flowchart of the operation of the magnetic disk device 20 to receive a command.

First, when the host device 1 is turned on by the operation on the power button (not illustrated), and the power supply to the magnetic disk device 20 starts, the elapsed time counter 30 starts counting (S11).

Subsequently, the command receiver 201 checks whether the boot-time disabling flag stored in the storage module 206 is set (S12). Having determined that the boot-time disabling flag is set (Yes at S12), the command receiver 201 determines that incorrect operation may be performed during last operation. Accordingly, the encryption key disabling module 205 disables an encryption key (S31), and the process ends.

On the other hand, having determined that the boot-time disabling flag is not set (No at S12), the command receiver 201 checks whether the unauthorized use flag is set (S13).

Having determined that the unauthorized use flag is set (Yes at S13), the command receiver 201 determines that incorrect operation is performed during last operation. Accordingly, the encryption key disabling module 205 disables the encryption key (S31), and the process ends.

On the other hand, having determined that neither the boot-time disabling flag nor the unauthorized use flag is set (No at S13), the command receiver 201 is ready to receive an authentication command (S14), and waits until an authentication command is received from the host device 1 (No at S15). Upon receipt of an authentication command from the host device 1 (Yes at S15), the time information determination module 202 performs time information determination process with respect to the authentication command (S16). The time information determination process will be described in detail below with reference to FIG. 5.

FIG. 5 is a detailed flowchart of the time information determination process at S16 of FIG. 4. First, the time information determination module 202 determines whether the authentication command contains time information (S161). Having determined that the authentication command does not contain time information (No at S161), the time information determination module 202 determines that the received authentication command is an unauthorized command. Accordingly, the encryption key disabling module 205 disables the encryption key (S167), and the process ends.

On the other hand, having determined that the authentication command contains time information (Yes at S161), the time information determination module 202 determines whether the storage module 206 stores last receiving time information (S162). If the time information determination module 202 determines that the storage module 206 does not store last receiving time information (No at S162), the process moves to S168.

On the other hand, having determined that the storage module 206 stores last receiving time information (Yes at S162), the time information determination module 202 reads the last receiving time information from the storage module 206 (S163). Then, from the difference between a counter value contained in the last receiving time information and a current counter value of the elapsed time counter 30, the time information determination module 202 calculates the elapsed time from the last receipt of an authentication command until the authentication command is received this time (S164).

After that, the time information determination module 202 adds the elapsed time calculated at S164 to time information contained in the last receiving time information, thereby deriving a calculation time (S165). The time information determination module 202 compares the calculation time with the time information contained in the input authentication command, and determines whether a value (the number of seconds) indicated by the time information is equal to or above a value (the number of seconds) indicated by the calculation time (S166).

With reference to FIG. 6, the process from S164 to S166 of FIG. 5 will be described in detail below. FIG. 6 is a schematic diagram for explaining the time information determination process. In the example of FIG. 6, first, the host device 1 transmits an authentication command (hereinafter, “first authentication command”) at Nov. 11, 2010 13:14:15, and the magnetic disk device 20 receives the first authentication command. In FIG. 6, the first authentication command contains a password “ABCDEFGH” and time information “D08A5F27”. The magnetic disk device 20 receives the first authentication command when the counter value of the elapsed time counter 30 is 100 (seconds). Thus, a combination of the time information “D08A5F27” and the counter value “100” is stored as last receiving time information at S168 of FIG. 5, which will be described later.

After that, the host device 1 transmits an authentication command (hereinafter, “second authentication command”) at Nov. 11, 2010 13:24:15, and the magnetic disk device 20 receives the second authentication command. In FIG. 6, the second authentication command contains a password “ABCDEFGH” as with the first authentication command and time information “D08A617F”. The magnetic disk device 20 receives the second authentication command when the counter value of the elapsed time counter 30 is 700 (seconds).

If a request command is in the condition illustrated in FIG. 6, the time information determination module 202 determines that the difference “600” between the counter value “100” upon receipt of the first authentication command and the counter value “700” upon receipt of the second authentication command as the elapsed time from the receipt of the first authentication command until the receipt of the second authentication command. Besides, the time information determination module 202 adds the elapsed time “600” to the time information “D08A5F27” contained in the first authentication command to derive the calculation time “D08A617F”. The time information determination module 202 compares the calculation time “D08A617F” with the time information “D08A617F” contained in the second authentication command to make a determination on the temporal difference.

Referring back to FIG. 5, if the value (the number of seconds) indicated by the time information is less than the value (the number of seconds) indicated by the calculation time (No at S166), a mismatch occurs in the temporal relationship between the calculation time and the time information. Thus, the time information determination module 202 determines that the time information is invalid (inconsistent). Accordingly, the encryption key disabling module 205 disables the encryption key (S167), and the process ends.

On the other hand, if the value (the number of seconds) indicated by the time information is equal to or above the value (the number of seconds) indicated by the calculation time (Yes at S166), no mismatch occurs in the temporal relationship between the calculation time and the time information. Thus, the time information determination module 202 determines that the time information is valid (consistent). The time information determination module 202 stores the time information contained in the authentication command received this time in association with the counter value of the elapsed time counter 30 when the authentication command is received in the storage module 206 as last receiving time information (S168). The, the process moves to S17 of FIG. 4.

Incidentally, at S166, if the value indicated by the time information is equal to or above the value indicated by the calculation time, the time information is determined to be valid for the following reason: If the magnetic disk device 20 is turned off after last receiving time information is stored, the elapsed time counter 30 starts counting from counter value 0. In this case, the value (the number of seconds) indicated by the time information exceeds the value (the number of seconds) indicated by the calculation time. This is normal operation, and therefore the use of the magnetic disk device 20 is not to be limited. On the other hand, it does not usually occur that the value indicated by the time information is less than the value indicated by the calculation time. Therefore, the time information is determined to be invalid, and the use of the magnetic disk device 20 is limited.

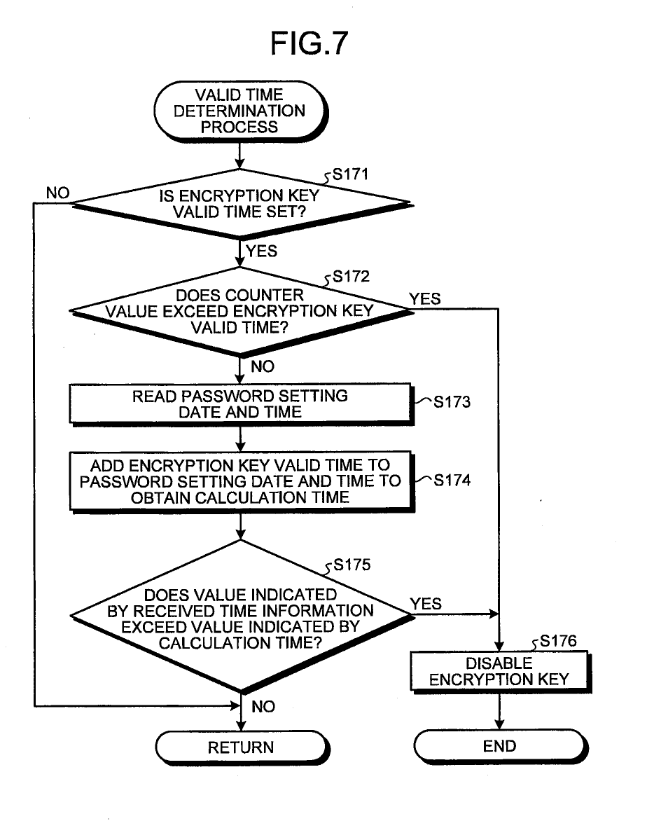

Referring back to FIG. 4, the valid time determination module 203 performs valid time determination process (S17). The valid time determination process will be described in detail below with reference to FIG. 7. FIG. 7 is a detailed flowchart of the valid time determination process at S17 of FIG. 4. First, the valid time determination module 203 checks whether the encryption key valid time is set in the storage module 206 (S171). If the encryption key valid time is not set (No at S171), the process moves to S18 of FIG. 4. Having determined that the encryption key valid time is set (Yes at S171), the valid time determination module 203 determines whether the current counter value of the elapsed time counter 30 exceeds the encryption key valid time (S172).

Having determined that the current counter value exceeds the encryption key valid time (Yes at S172), the valid time determination module 203 determines that the encryption key expires. In this case, the encryption key disabling module 205 disables the encryption key (S176), and the process ends.

On the other hand, having determined that the current counter value of the elapsed time counter 30 does not exceed the encryption key valid time (No at S172), the process moves to S173. The determination at S172 is performed for the case where the time has passed without a single password authentication after the host device 1 is turned on.

The valid time determination module 203 then reads password setting date and time from the storage module 206 (S173). The valid time determination module 203 adds the encryption key valid time to the password setting date and time to obtain a calculation time (S174). The valid time determination module 203 compares the calculation time obtained at S174 with the time information contained in the authentication command received this time, and determines whether a value (the number of seconds) indicated by the time information exceeds a value (the number of seconds) indicated by the calculation time (S175).

Having determined that the value indicated by the time information exceeds the value indicated by the calculation time (Yes at S175), the valid time determination module 203 determines that the encryption key expires. In this case, the encryption key disabling module 205 disables the encryption key (S176), and the process ends. On the other hand, if the value indicated by the time information is equal to or below the value indicated by the calculation time (No at S175), the process moves to S18 of FIG. 4.

As described above, in the magnetic disk device 20 of the embodiment, the valid time (date) of the encryption key is set. If the valid date expires, the encryption key is disabled. Thus, in the case, for example, where someone makes off with the magnetic disk device 20, the security of the magnetic disk device 20 is improved. While the valid time determination process is described herein as being performed when the authentication command is checked, the determination as to whether it falls within the encryption key valid time may be additionally performed by only the encryption key valid time and the counter value of the elapsed time counter 30 during the waiting time for the receipt of an authentication command.

Referring back to FIG. 4, the password authentication module 204 determines that the authentication command received at S15 is one of those received sequentially in a short time (S18). For example, if the magnetic disk device 20 is subjected to a brute force attack, numerous combinations of character strings are received at high speed as passwords. To prevent such an incorrect login attempt, at S18, it is detected whether authentication commands are received sequentially in a short time.

Having determined that authentication commands are received sequentially in a short time (Yes at S18), the password authentication module 204 determines that incorrect operation is performed. In this case, the encryption key disabling module 205 disables the encryption key (S31), and the process ends.

On the other hand, having determined that authentication commands are not received sequentially in a short time (No at S18), the password authentication module 204 compares a password contained in the received authentication command with a check password stored in the storage module 206 to determine whether the passwords match (S19).

Having determined that the passwords do not match (No at S19), the password authentication module 204 increments authentication request count by 1 (S20). The authentication request count is a variable to record the number of times password authentication fails, and is stored in the buffer memory 31, the storage module 206, or the like.

Then, the password authentication module 204 determines that incorrect operation may be performed, and sets a boot-time disabling flag (S21). Subsequently, the password authentication module 204 determines whether the authentication request count exceeds a predetermined count (hereinafter, “authentication available count”). If the authentication request count is equal to or less than the authentication available count (No at S22), the password authentication module 204 notifies the host device 1 that the passwords do not match (S23). Then, the process returns to S15.

On the other hand, having determined that the authentication request count exceeds the authentication available count (Yes at S22), the password authentication module 204 checks whether an unauthorized use flag is set (S24). If an unauthorized use flag is set (Yes at S24), the password authentication module 204 determines that incorrect operation is performed. In this case, the encryption key disabling module 205 disables the encryption key (S31), and the process ends.

If an unauthorized use flag is not set (No at S24), the password authentication module 204 sets an unauthorized use flag (S25). With the setting of the unauthorized use flag at S25, the command receiver 201 stops receiving commands from the host device 1 for a predetermined time period (S26).

The process of S26 is performed not to defend against a password attack, but is aimed at temporarily saving data on the disk medium 21 when an incorrect password is input a plurality of times for the purpose of cracking (intentionally deleting data on the disk medium 21). While the receipt of commands is stopped, the host device 1 can detect that a problem occurs on the magnetic disk device 20 since a command response is not returned from the magnetic disk device 20. By providing the host device 1 with a mechanism to automatically notify the administrator of a problem in the magnetic disk device 20, it is possible to take quick action to fix the problem.

The command receiver 201 waits until the predetermined time period has elapsed (No at S27). After the predetermined time period has elapsed (Yes at S27), the command receiver 201 is ready again to receive commands (S28). Then, the process returns to S15.

Having determined that the passwords match (Yes at S19), the password authentication module 204 clears the boot-time disabling flag and the unauthorized use flag, and resets the authentication request count to 0 (S29). After that, the MPU 35 performs process in response to the input command such as, for example, data read or write operation (S30). Then, the process returns to S15.

As described above, according to the embodiment, upon receipt of a command from the host device 1, the magnetic disk device 20 determines the consistency of time information based on the time information contained in an authentication command and a counter value of the elapsed time counter 30. Only if the consistency is confirmed, password authentication is performed. This enables to authenticate the host device 1 that is attempting to access the magnetic disk device 20. Thus, the security of the magnetic disk device 20 can easily be improved.

While two flags, i.e., the boot-time disabling flag and the unauthorized use flag, are used in the above embodiment, only the unauthorized use flag may be used. Further, while the encryption key is disabled if the boot-time disabling flag is set when the magnetic disk device 20 is turned on (booted), it is not so limited. The encryption key may be disabled only if the unauthorized use flag is set.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device configured to encrypt data with an encryption key, to store the data in a storage area and to decrypt the data stored in the storage area with the encryption key, the storage device comprising:
an elapsed time counter configured to start counting triggered by turning on of the storage device;
a receiver configured to receive a command that contains a password and time information from a host device connected to the storage device, the time information indicating current date and time measured by the host device;
a calculator configured to calculate elapsed time from last command input to current command input based on the time information contained in the command and a counter value counted by the elapsed time counter until the command is received;
an adder configured to add the elapsed time calculated by the calculator to time information contained in a last command received last time;
a time information determination module configured to determine consistency of the time information contained in the current command based on a temporal relationship between a result of addition by the adder and the time information;
a disabling module configured to disable the encryption key if the time information determination module determines that the time information is not consistent; and
an authentication module configured to authenticate the password contained in the current command if the time information determination module determines that the time information is consistent, and allow access to the storage area if the password is successfully authenticated.

2. The storage device of claim 1, wherein, if the date and time indicated by the time information contained in the current command is equal to or exceeds date and time indicated by the elapsed time calculated by the calculator, the time information determination module determines that the time information is consistent.

3. The storage device of claim 1, further comprising a valid time determination module configured to compare encryption key valid time defined as a time period during which the encryption key is valid with the counter value of the elapsed time counter and, if the counter value exceeds the encryption key valid time, to determine that the encryption key expires, wherein
if the valid time determination module determines that the encryption key expires, the disabling module disables the encryption key.

4. The storage device of claim 3, wherein
the time information determination module is configured to add the encryption key valid time to password setting date and time indicating date and time when the password is set, and
if date and time indicated by a result of addition exceeds the date and time indicated by the time information contained in the command, the time information determination module determines that the encryption key expires.

5. The storage device of claim 1, further comprising a determination module configured to detect input count indicating how many times the command is received per unit time and determine whether the input count exceeds a predetermined threshold, wherein
if the determination module determines that the input count exceeds the threshold, the disabling module disables the encryption key.

6. The storage device of claim 1, wherein the disabling module is configured to delete the encryption key or to replace the encryption key with a different character string.

7. The storage device of claim 1, wherein, if password authentication by the authentication module fails a predetermined number of times, the receiver stops receiving a command for a predetermined time period.

8. A method of protecting a storage device configured to encrypt data with an encryption key, to store the data in a storage area and to decrypt the data stored in the storage area with the encryption key, the method comprising:
start counting triggered by turning on of the storage device;
receiving a command that contains a password and time information from a host device connected to the storage device, the time information indicating current date and time measured by the host device;
calculating elapsed time from last command input to current command input based on the time information contained in the command and a counter value counted until the command is received;
adding the elapsed time calculated at the calculating to time information contained in a last command received last time;
determining consistency of the time information contained in the current command based on a temporal relationship between a result of addition at the adding and the time information;
disabling the encryption key if the time information is determined to be not consistent; and
authenticating the password contained in the current command if the time information is determined to be consistent, and allowing access to the storage area if the password is successfully authenticated.

9. The method of claim 8, wherein, if the date and time indicated by the time information contained in the current command is equal to or exceeds date and time indicated by the elapsed time calculated at the calculating, it is determined at the determining that the time information is consistent.

10. The method of claim 8, further comprising comparing encryption key valid time defined as a time period during which the encryption key is valid with the counter value of the elapsed time counter and, if the counter value exceeds the encryption key valid time, determining that the encryption key expires, wherein
if the encryption key expires, the encryption key is disabled at the disabling.

11. The method of claim 10, wherein
the determining includes adding the encryption key valid time to password setting date and time indicating date and time when the password is set, and
if date and time indicated by a result of addition exceeds the date and time indicated by the time information contained in the command, it is determined at the determining that the encryption key expires.

12. The method of claim 8, further comprising detecting input count indicating how many times the command is received per unit time and determining whether the input count exceeds a predetermined threshold, wherein
if the input count exceeds the threshold, the encryption key is disabled at the disabling.

13. The method of claim 8, wherein the disabling includes deleting the encryption key or to replacing the encryption key with a different character string.

14. The method of claim 8, wherein, if password authentication by the authentication module fails a predetermined number of times, a command is not received at the receiving for a predetermined time period.

15. An electronic device comprising:
a storage device configured to encrypt data with an encryption key, to store the data in a storage area and to decrypt the data stored in the storage area with the encryption key;
a timer configured to generate time information indicating current date and time; and
a transmitter configured to transmit a command containing a predetermined password and the time information to the storage device to access the storage device, wherein
the storage device comprises
an elapsed time counter configured to start counting triggered by turning on of the storage device;
a receiver configured to receive the command from the transmitter;
a calculator configured to calculate elapsed time from last command input to current command input based on the time information contained in the command and a counter value counted by the elapsed time counter until the command is received;
an adder configured to add the elapsed time calculated by the calculator to time information contained in a last command received last time;
a time information determination module configured to determine consistency of the time information contained in the current command based on a temporal relationship between a result of addition by the adder and the time information;
a disabling module configured to disable the encryption key if the time information determination module determines that the time information is not consistent; and
an authentication module configured to authenticate the password contained in the current command if the time information determination module determines that the time information is consistent, and allow access to the storage area if the password is successfully authenticated.

16. The electronic device of claim 15, wherein, if the date and time indicated by the time information contained in the current command is equal to or exceeds date and time indicated by the elapsed time calculated by the calculator, the time information determination module determines that the time information is consistent.

17. The electronic device of claim 15, further comprising a valid time determination module configured to compare encryption key valid time defined as a time period during which the encryption key is valid with the counter value of the elapsed time counter and, if the counter value exceeds the encryption key valid time, to determine that the encryption key expires, wherein
if the valid time determination module determines that the encryption key expires, the disabling module disables the encryption key.

18. The electronic device of claim 17, wherein
the time information determination module is configured to add the encryption key valid time to password setting date and time indicating date and time when the password is set, and
if date and time indicated by a result of addition exceeds the date and time indicated by the time information contained in the command, the time information determination module determines that the encryption key expires.

19. The electronic device of claim 15, further comprising a determination module configured to detect input count indicating how many times the command is received per unit time and determine whether the input count exceeds a predetermined threshold, wherein
if the determination module determines that the input count exceeds the threshold, the disabling module disables the encryption key.

20. The electronic device of claim 15, wherein, if password authentication by the authentication module fails a predetermined number of times, the receiver stops receiving a command for a predetermined time period.
